(19) United States
(12) Patent Application Publication
(10) Pub. No.: US 2024/0428174 A1
(43) Pub. Date: Dec. 26, 2024

(54) METHOD AND SYSTEM FOR CONSISTENT AND SCALABLE DATA ANNOTATION IN GLOBAL FACTORY NETWORKS

(71) Applicant: HITACHI, Ltd., Tokyo (JP)

(72) Inventors: Sudhanshu GAUR, Cupertino, CA (US); Joydeep ACHARYA, Milpitas (CA)

(21) Appl. No.: 18/212,950

(22) Filed: Jun. 22, 2023

(51) Int. Cl. G06Q 10/067; G06N 5/022; G06Q 10/0639

(52) U.S. Cl. CPC G06Q 10/067; G06N 5/022; G06Q 10/06395; G06F 40/186; G06Q 50/04

(57) ABSTRACT

Systems and methods for automating process setting to a target factory, which can involve creating templatized business terms, templatized business data configurator logics, and a templatized data profile by machine learning from training data from at least one reference factory; storing the templatized business terms, the templatized business data configurator logics, and the templatized data profile into a knowledge graph; querying the knowledge graph with a data profile of the target factory to obtain corresponding templated business terms; and applying the corresponding templated business terms and corresponding templated business data configurator logics to a data catalogue of the target factory.

### BACKGROUND

### Field

The present disclosure is generally directed to factory networks, and more specifically, to consistent and scalable data annotation across target factory networks.

### Related Art

Modem industrial practices are moving to a data driven operation. One of the challenges to be overcome is the huge gap between data collected from subsystems involving the industry vertical (e.g. manufacturing) and the way the business owners of stakeholders understand the data. This is because the data collection follows Information Technology (IT) standards and data models while the stakeholders who come from the Operation Technology (OT) world, understand the context of the data but not necessarily the details of the IT data models.

In many industries this IT/OT divide is solved by a dedicated data steward who effectively understands both these worlds and can provide the business terms for data which capture OT context and also help in translating IT data models to business data that the OT world can utilize. However, these require deep domain knowledge of both worlds and organizations find it difficult to hire a full time individual or individuals for this purpose and effectively integrate in their existing chain of operations. More often than not, it becomes an additional task for an existing employee or employees in the company. This may work well for an individual company with skilled employees who can take the time to talk to other employees to fill in the gaps of their understanding (IT and/or OT aspects). This task is done using software tools called data catalogues which can record the IT data, allow data stewards to input business terms and then supervise the IT data to business terms translation.

In the related art, there are implementations that involve an identifying and categorizing method of data through advanced machine learning algorithms, which provides a visual representation of the category of data infrastructure distributed across data-centers and multiple clusters.

In the related art, there are also systems, methods, tools, and computer programming products for implementing a cognitive data lake that selects or recommends operation database based on historically created data lakes.

### SUMMARY

However, many large industrial conglomerates comprise of many group companies. Many of those companies may produce the same product, have similar processes and business data. Indeed, often when a conglomerate sets up a new company in a new geographical region, it tries to replicate an existing company in terms of products and processes. There is sufficient similarity in the business data and the business processes as a result. The IT data may however look vastly different depending on the choice of IT software selection. In this case, there is some value in trying to learn from the IT data to business data translation from one company, the nature of correlation between the company and another company in terms of their business data and processes, and then create an automated method to do the translation from the IT data to business data translation from the other company. The present disclosure herein involves systems and methods to replicate data catalogues across multiple companies belonging to the same industrial conglomerate consistently without the need of dedicated data stewards and business data configurators at each company. This in essence automates the job of a data steward who would otherwise be in charge of providing the business logic and deriving the business data. This is beneficial as many companies may not have the capability to employ a dedicated data steward.

Example implementations described herein replicate data catalogues across multiple companies belonging to the same industrial conglomerate consistently without the need of dedicated data stewards and business data configurators at each company.

Example implementations described herein learn from the IT data to business data translation from a reference company, the nature of correlation between the reference company and another target company in terms of their business description (data and processes) and then create an automated method to do the translation from the IT data to business data translation from the target company. The automated method involves an automated business logic configurator and an automated business data configurator.

Aspects of the present disclosure can include a method for automating process setting to at least one target factory, which can involve creating templatized business terms, templatized business data configurator logics, and a templatized data profile by machine learning from training data from at least one reference factory; storing the templatized business terms, the templatized business data configurator logics, and the templatized data profile into a knowledge graph; querying the knowledge graph with a data profile of the target factory to obtain corresponding templated business terms and corresponding templated business data configurator logics; and applying the corresponding templated business terms and the corresponding templated business data configurator logics to a data catalogue of the target factory.

Aspects of the present disclosure can include a computer program for automating process setting to at least one target factory, which can involve instructions involving creating templatized business terms, templatized business data configurator logics, and a templatized data profile by machine learning from training data from at least one reference factory; storing the templatized business terms, the templatized business data configurator logics, and the templatized data profile into a knowledge graph; querying the knowledge graph with a data profile of the target factory to obtain corresponding templated business terms and corresponding templated business data configurator logics; and applying the corresponding templated business terms and the corresponding templated business data configurator logics to a data catalogue of the target factory. The computer program and the instructions can be stored in a non-transitory computer readable medium and executed by one or more processors.

Aspects of the present disclosure can include a system for automating process setting to at least one target factory, which can involve means for creating templatized business terms, templatized business data configurator logics, and a templatized data profile by machine learning from training data from at least one reference factory; means for storing the templatized business terms, the templatized business data configurator logics, and the templatized data profile into a knowledge graph; means for querying the knowledge graph with a data profile of the target factory to obtain corresponding templated business terms and corresponding templated business data configurator logics; and means for applying the corresponding templated business terms and the corresponding templated business data configurator logics to a data catalogue of the target factory.

Aspects of the present disclosure can include an apparatus, which can involve a processor, configured to create templatized business terms, templatized business data configurator logics, and a templatized data profile by machine learning from training data from at least one reference factory; store the templatized business terms, the templatized business data configurator logics, and the templatized data profile into a knowledge graph; query the knowledge graph with a data profile of the target factory to obtain corresponding templated business terms and corresponding templated business data configurator logics; and apply the corresponding templated business terms and the corresponding templated business data configurator logics to a data catalogue of the target factory.

### BRIEF DESCRIPTION OF DRAWINGS

FIG. 1 illustrates the overall flow of the data catalogue process, in accordance with an example implementation.

FIG. 2 illustrates an example of a multi entity knowledge module training for reference factories, in accordance with an example implementation.

FIG. 3 illustrates an example of multi entity knowledge module application for target factories, in accordance with an example implementation.

FIG. 4 illustrates the data profiler, in accordance with an example implementation.

FIG. 5 illustrates the multi entity knowledge module 200, in accordance with an example implementation.

FIG. 6 illustrates the flow for the business knowledge creation module, in accordance with an example implementation.

FIG. 7 illustrates the interrelationships between input for reference factories, in accordance with an example implementation.

FIG. 8 illustrates an example of correlated clusters from the input for reference factories, in accordance with an example implementation.

FIG. 9 illustrates an example of a subset of IT data as appearing from a reference company, in accordance with an example implementation.

FIG. 10 illustrates an example data profile for the reference company, in accordance with an example implementation.

FIG. 11 illustrates an example of the business terms, in accordance with an example implementation.

FIG. 12 illustrates an example of the business data generated from the IT data profile using the business terms, in accordance with an example implementation.

FIG. 13 illustrates an example of the knowledge graph, in accordance with an example implementation.

FIG. 14 illustrates an example flow for the business knowledge inference module, in accordance with an example implementation.

FIG. 15 illustrates an example of the IT data in the target company, in accordance with an example implementation.

FIG. 16 illustrates an example of the data profile a in the target company, in accordance with an example implementation.

FIG. 17 illustrates an example of the business data in the target factory, in accordance with an example implementation.

FIG. 18 illustrates a plurality of physical systems that are networked to a management apparatus, in accordance with an example implementation.

FIG. 19 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

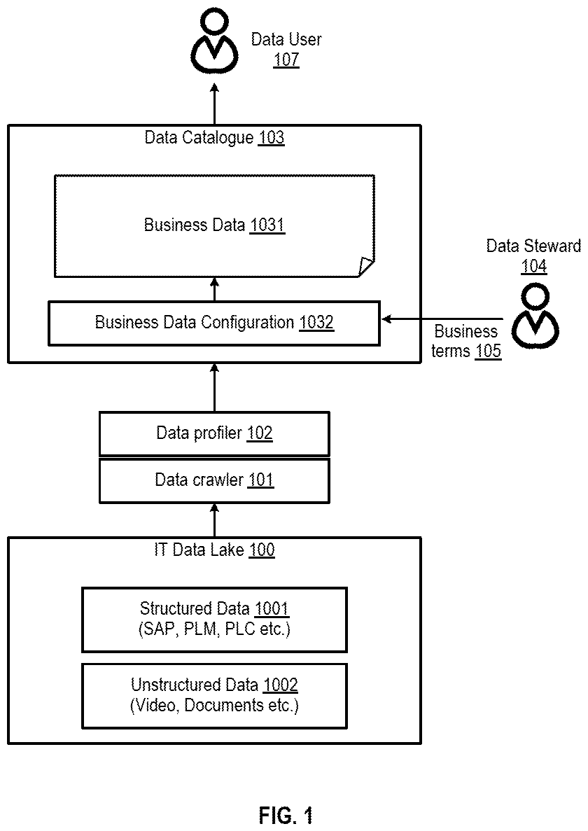

FIG. 1 illustrates the overall flow of the data catalogue process, in accordance with an example implementation. It includes an IT data lake 100 which stores structured data 1001 from various systems in the company such as enterprise resource planning (ERP), product lifecycle management (PLM), Industrial Internet of Things (IioT), and so on. Such data would be stored over many different types of IT databases such as relational databases and NoSQL databases. There is also unstructured data 1002 such as video. This feeds into a data crawler 101 which finds all the data in data lake and develops the list of data in the data lake. Then there is a data profiler 102, which profiles the data for the data search such as frequency of data, min and max values and other results from exploratory data analysis and profiling. The results of the data profiler feed into a data catalogue 103. A data steward 104 provides the data catalogue 103 with business terms information 105. Specifically, the business terms information 105 goes into the Business Data Configurator 1032 of Data Catalogue 103, which then generates the Business Data 1031. This is utilized by the data user 107 who can be a data scientist who will develop Artificial Intelligence (AI) models on the data, a manager looking for dashboards and any number of other personas.

For illustration purposes, assume that there are two types of factories. The first type is referred to herein as Reference Factories for which all information such as Data Profiler 102, Business Terms 105, and Business Terms Configurator 1032 are available. The second type is referred to as Target Factories for which only the Data Profiler 102 are available. The Target factories do not have Data Steward 104 to produce Business Terms 105 and also do not have the Business Terms Configurator 1032 to produce the Business Data needed for the Data Catalog.

In example implementations described herein, it is presumed that the Reference and Target Factories belong to the same business conglomerate. The example implementations can therefore use this relationship to derive correlations between the various information from these factories to derive the Business Terms and Business Terms Configuration logic for the Target factories as well.

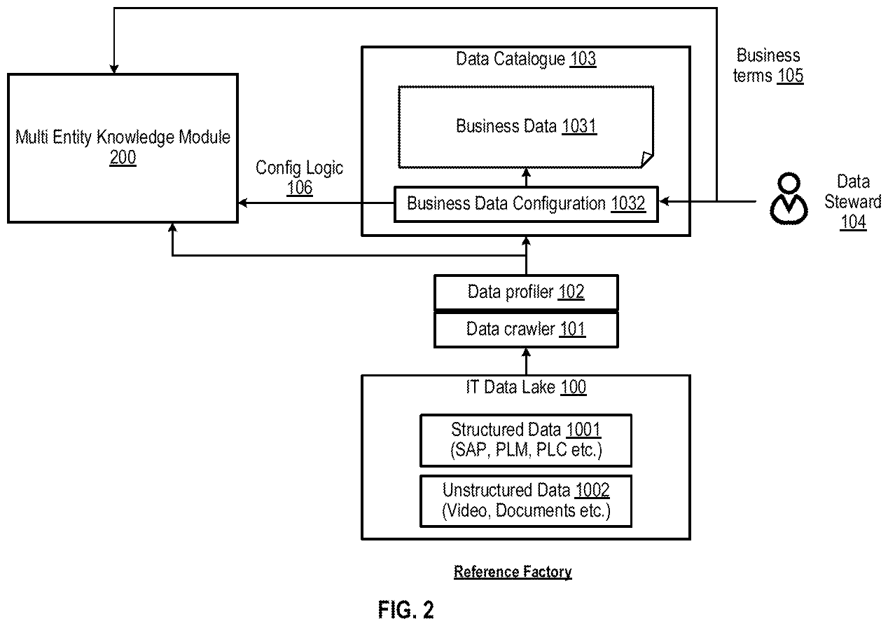

FIG. 2 illustrates an example of a multi entity knowledge module training for reference factories, in accordance with an example implementation. Specifically, FIG. 2 illustrates the training phase of the Multi Entity Knowledge Module 200 where it interacts with the various information from the reference factories. Business terms 105 are processed as input for the reference factories. Multi Entity Knowledge Module 200 also intakes Business Data configurator logic 106, which was used to generate the Business data from the IT data profile for the reference factories. Multi Entity Knowledge Module 200 also intakes the data profiler results 102 for the Reference factories. During the training process as shown in FIG. 2, the Multi Entity Knowledge Module 200 is trained over the information from the reference factories.

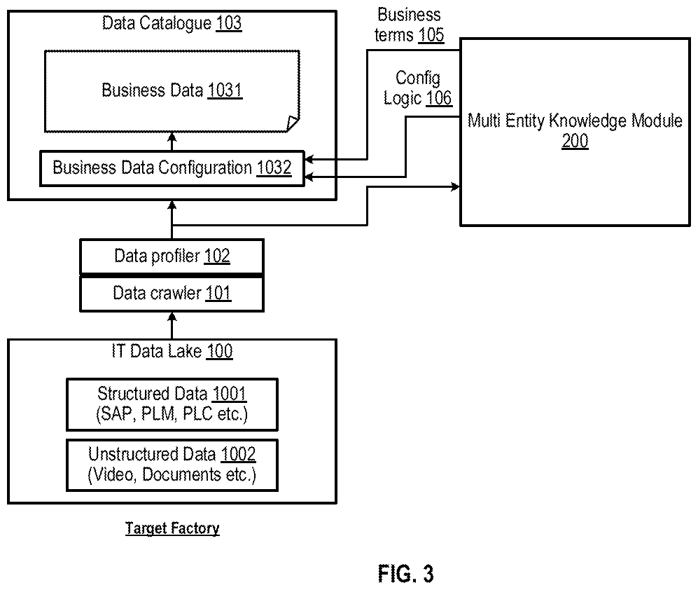

FIG. 3 illustrates an example of multi entity knowledge module application for target factories, in accordance with an example implementation. For FIG. 3, the Multi Entity Knowledge Module 200 can be applied to a new factory, referred to herein as the target factory. This is called the application phase of the multi entity knowledge module 200. In this phase, it takes data profiler results 102 from the target factory as the input and generates the business terms 105 without the need of a data steward at the target factory. Multi entry knowledge module 200 can also generate the business data configurator logic 106 which is input to the Business Data Configurator 1032, which is then able to generate the business data 1031 for the target factory.

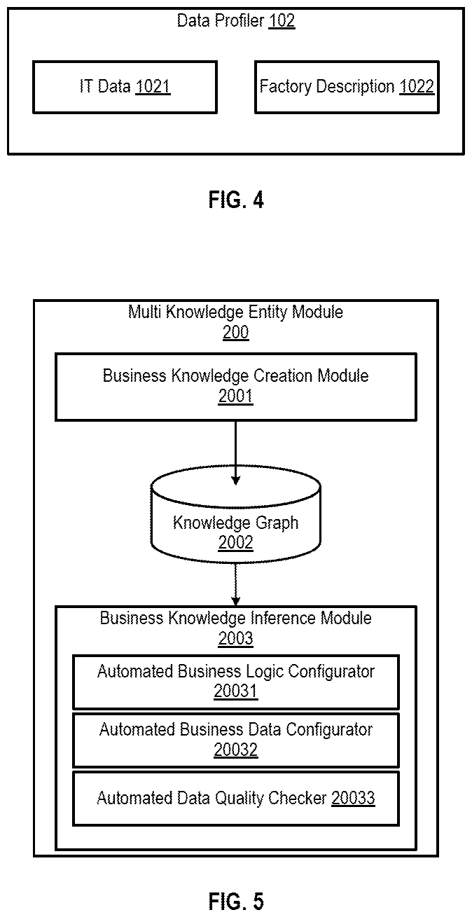

FIG. 4 illustrates the data profiler 102, in accordance with an example implementation. Data profiler 102 can involve the IT data profile 1021 and also a more general factory description 1022. This could be metadata about the factory such as about its business, production and general information.

FIG. 5 illustrates the multi entity knowledge module 200, in accordance with an example implementation. is shown in detail in Error! Reference source not found. The multi entity knowledge module can involve a Business Knowledge Creation Module 2001, Knowledge Graph 2002 and a Business Knowledge Inference Module 2003. The Business Knowledge Creation Module 2001 is used to train on the reference factory data as shown in FIG. 2. The result of the training is the Knowledge Graph 2002. The Business Knowledge Inference Module 2003 is used to generate the Data Catalogue in the target factory as shown in FIG. 3. To do this, the Business Knowledge Inference Module 2003 has two sub-modules, namely, the Automated Business Logic Configurator 20031 and the Automated Business Data Configurator 20032. These two modules in essence automate the job of a data steward who is not present in the target factory.

The Automated Data Quality Checker 20033 checks for the data quality of the target factory for any anomalies.

The relationship between the IT data profile, business terms and business data can be expressed mathematically as follows. Let d_{IT}(R), B^{(R)} and d_{B}(R) be the IT data profile, business terms and the business data of the reference company and d_{IT}(T), B^{(T)} and d_{B}(T) be the IT data profile, business terms and the business data of the target company. They are related by

d_{B}(R)=f_{R}(d_{IT}(R),B^{(R)})

d_{B}(T)=f_{T}(d_{IT}(T),B^{(T)})

The business terms B^{(R)} is provided by the data steward 104 in the reference company, the IT data profile d_{IT}(R), is the Data Profiler results 102 of the reference company, and the business data d_{IT}(R) is the same as business data 1031. The function f_{R}(⋅) is the business data configuration logic 106 which is implemented by the business data configurator 1032 in the reference company. For the reference factories, the quantities d_{B}(R), d_{IT}(R), B^{(R)} and f_{R}(⋅) are known, but for the target factory only d_{IT}(T) is known and the quantities B^{(T)} and f_{T}(⋅) have to be learned.

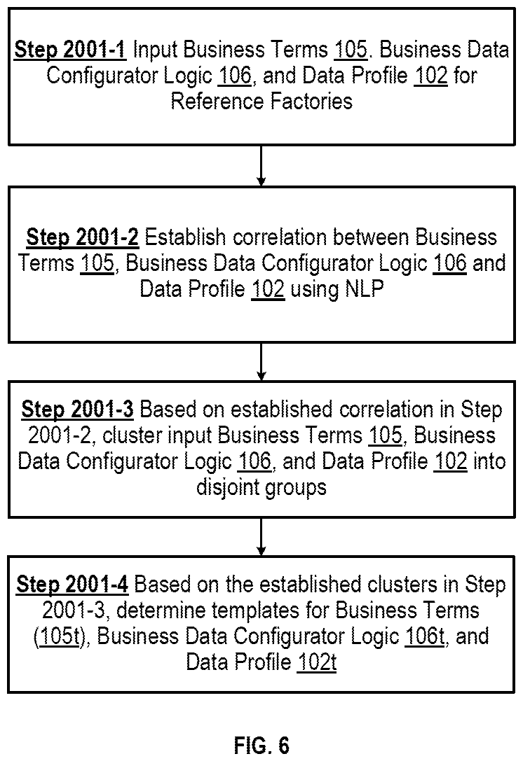

FIG. 6 illustrates the flow for the business knowledge creation module, in accordance with an example implementation. The flow for the business knowledge creation module can involve the following:

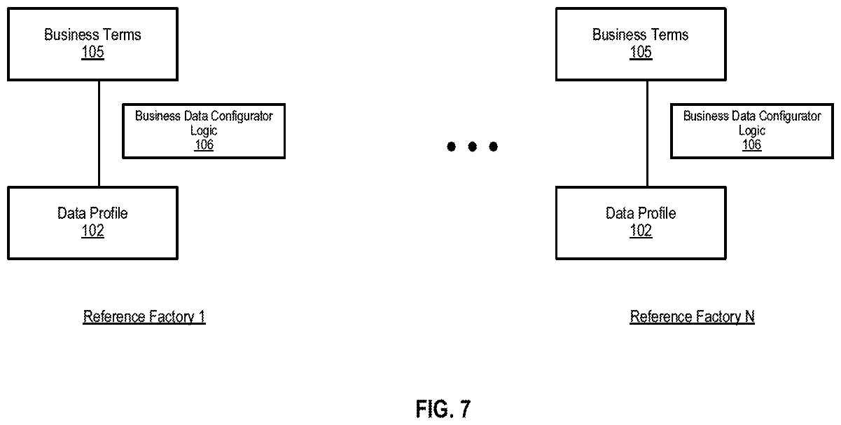

At Step 2001-1, the flow inputs Business Terms 105, Business Data Configurator Logic 106, and Data Profile 102 for Reference Factories. This is shown in FIG. 7 which shows the inter-relationships between these quantities for N reference factories.

At Step 2001-2, the flow establishes a correlation between Input Business Terms 105. Business Data Configurator Logic 106 and Data Profile 102 using Natural Language Programming (NLP). Since the Data Profile 102 includes Factory Description 1022, which is general metadata, Natural Language Processing (NLP) is used with Large Language Models (LLM) to find correlations in the information. The aim of this step is to discover relationships which define what constitutes unique situations in a factory with regards to its information and how information from another factory is similar or different. The example implementations are directed to covering multiple factories (or companies) belonging to the same conglomerate and thus it is expected that there will be such relationships.

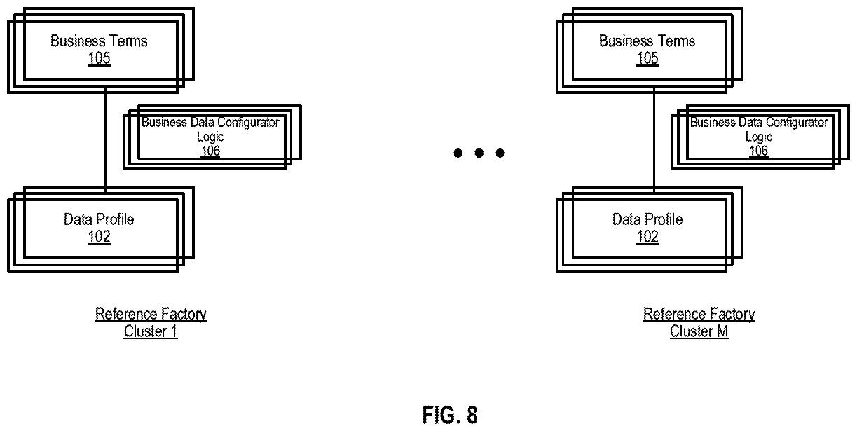

At Step 2001-3 based on the established correlation in Step 2001-2, the flow clusters Business Terms 105, Business Data Configurator Logic 106, and Data Profile 102 into disjoint groups. This is shown in more detail in FIG. 8. An entity in a cluster is related to entities within the same cluster more than entities in other clusters.

The specific nature of a cluster or how clustering is done can be facilitated by any desired implementation as known in the art.

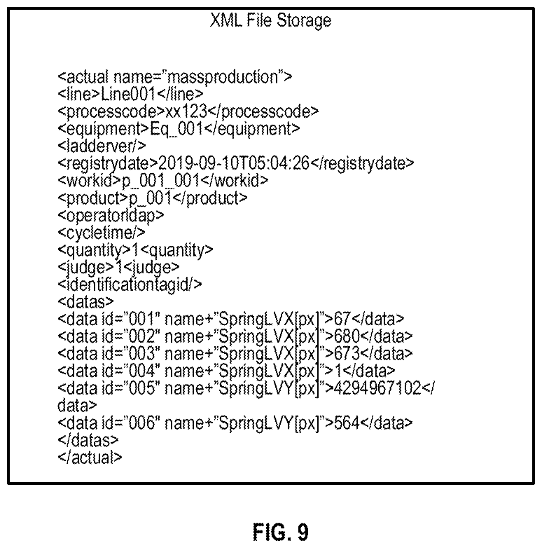

FIG. 9 illustrates an example of a subset of IT data as appearing from a reference company, in accordance with an example implementation. The data profiles can be clustered based on similarity analysis performed on the IT data profiler results. Specifically. FIG. 9 illustrates an example of how a subset of IT data may look from the reference company. The example pertains to manufacturing. As seen, it is in the form of an extensible markup language (XML) file store.

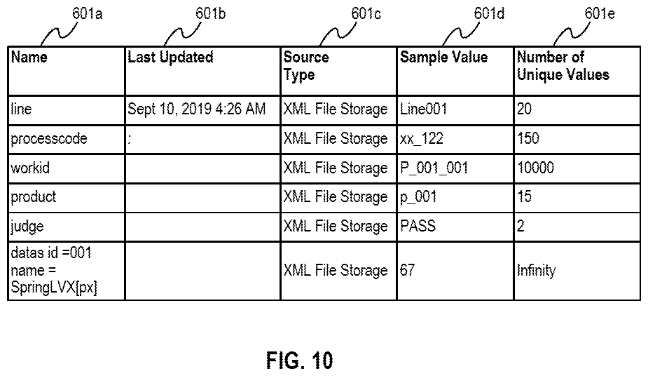

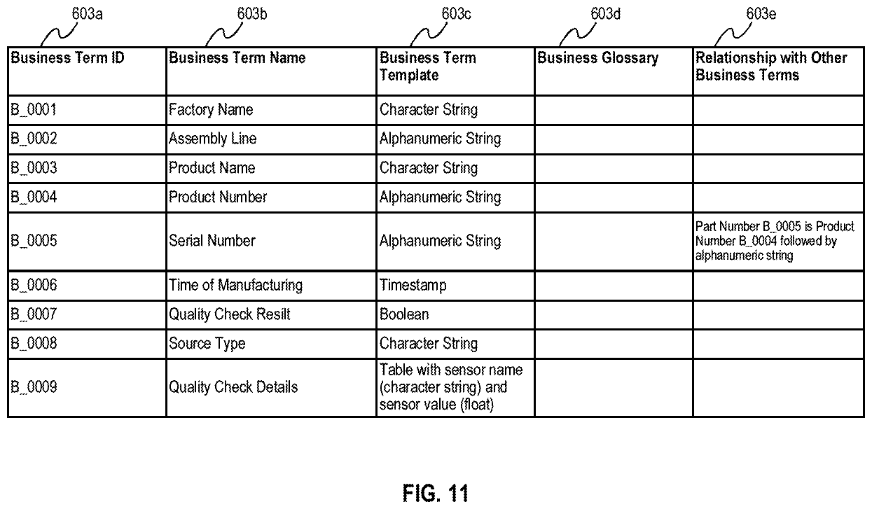

FIG. 10 illustrates an example data profile for the reference company, in accordance with an example implementation. The data profile can be generated by using available data catalogue software as known in the art. The IT data profile exhibits properties such as number of items and their frequency, relationship between different items (for e.g. the prefix of any entry in ‘Workid’ is the corresponding ‘product’ entry), and so on. These properties can then be used for clustering. Examples of fields that can be included in the data profile can include, but are not limited to, name 601a, when last updated 601b, source type 601c, sample value 601d, and number of unique values 601e.

FIG. 11 illustrates an example of the business terms, in accordance with an example implementation. The business terms can be clustered based on the business context. The corresponding business terms of FIG. 11 can be provided by the data steward. This is provided by the data steward. The business terms can include, but are not limited to, business term ID 603a, business term name 603b, template 603c, and glossary 603d with more detailed information which provide the business context on which two companies or factories may be deemed similar enough so as to belong to the same cluster. In addition, there can also be a relationship with other business terms 603e field to indicate the relationship between various business terms. For example, Factory Description 1022 can be used to reveal that two factories in different geographical regions produce the same product using the same manufacturing processes, or that one was set up based on the working model of the other one. In such cases, business data from these companies would belong to the same cluster.

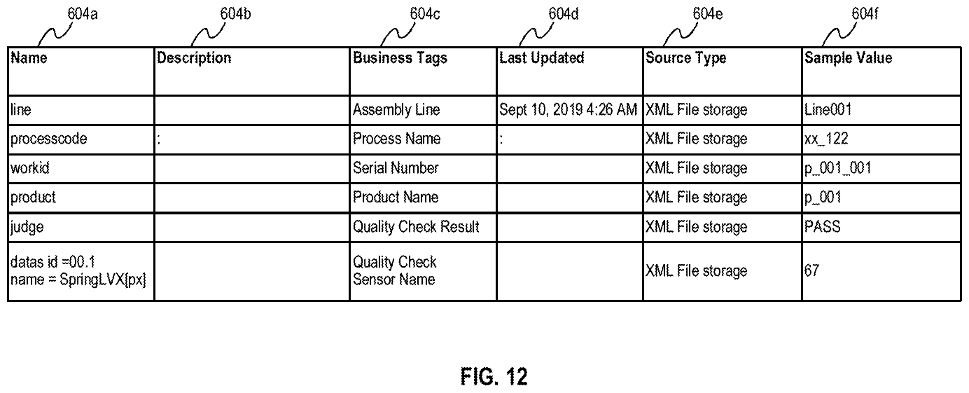

FIG. 12 illustrates an example of the business data generated from the IT data profile using the business terms, in accordance with an example implementation. The business data configurator logic may be clustered based on the logic by which business data is generated from the IT data profile by using the business terms. To understand this, consider the corresponding business data shown in FIG. 12. Note that it has added business tags on the IT data based on the information from the business terms and the configuration logic is in how the tags are placed. Depending on the exact nature and the degree of generalizability of this logic (for e.g., always assign the term with the greatest number of unique occurrences in the IT data profile term to the business term ‘Serial Number’), business logic can thereby be clustered. Examples of the fields for the business data can include, but are not limited to, name 604a, description 604b, business tags 604c, last updated 604d, source type 604e, and sample value 604f.

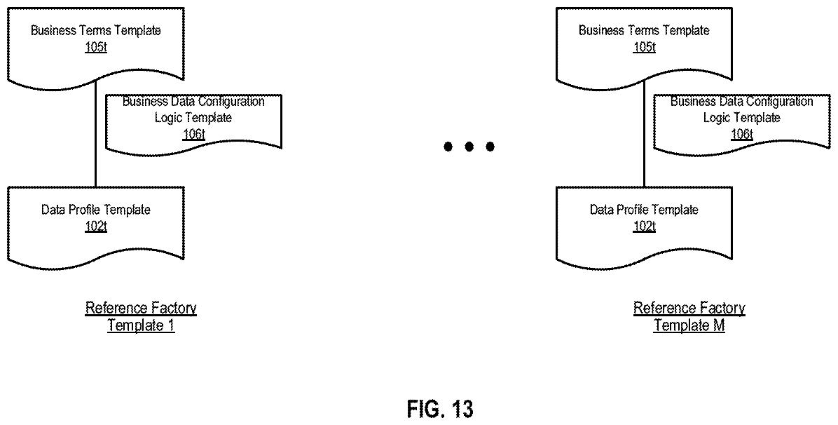

At Step 2001-4, based on established clusters in Step 2001-3, the flow determines templates for Business Terms (105t), Business Data Configurator Logic 106t, and Data Profile 102t. A given template summarizes the properties of all entities within a cluster. This is shown in the knowledge graph of FIG. 13.

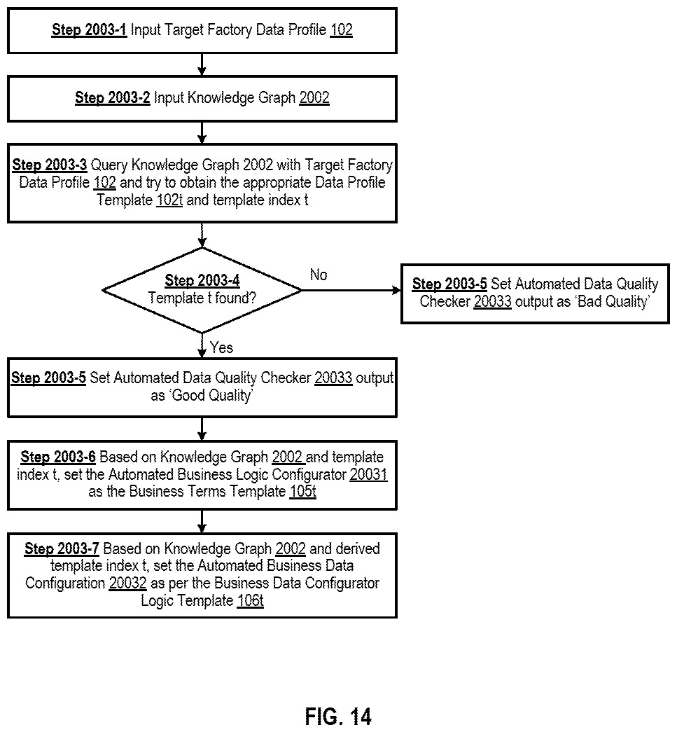

FIG. 14 illustrates an example flow for the business knowledge inference module, in accordance with an example implementation. This is the step where the target factory can derive its business terms and business data configurator logic. The flow can be as follows:

At Step 2003-1, the flow inputs the Target Factory Data Profile 102. At Step 2003-2, the flow inputs the Knowledge Graph 2002. At Step 2003-3, the flow queries the Knowledge Graph 2002 with the Target Factory Data Profile 102 and tries to obtain the appropriate Data Profile Template 102t and template index t. The specific nature of the mechanisms can be implemented in accordance with any desired implementation as known in the art.

As an example, the Target Factory Metadata Description contained in 1022 which is contained in Data Profile 102 can match closely to a Factory Description Metadata information in Template 102t.

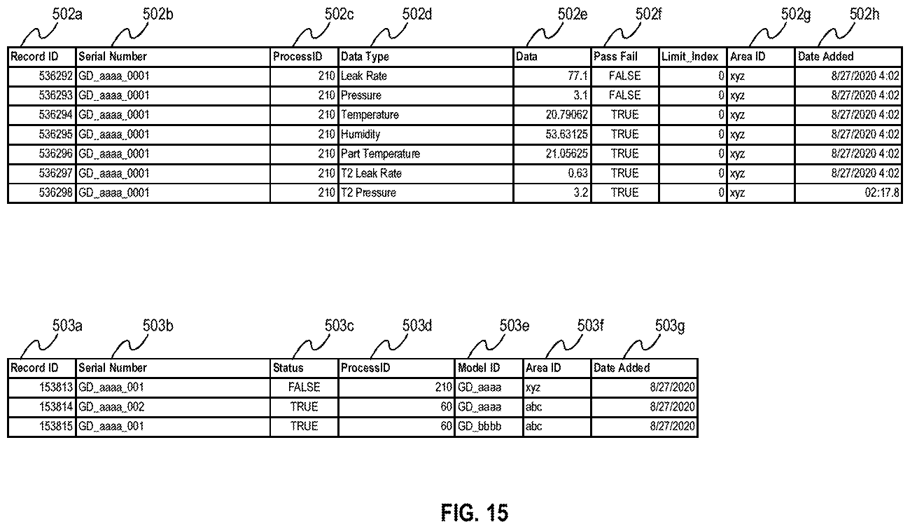

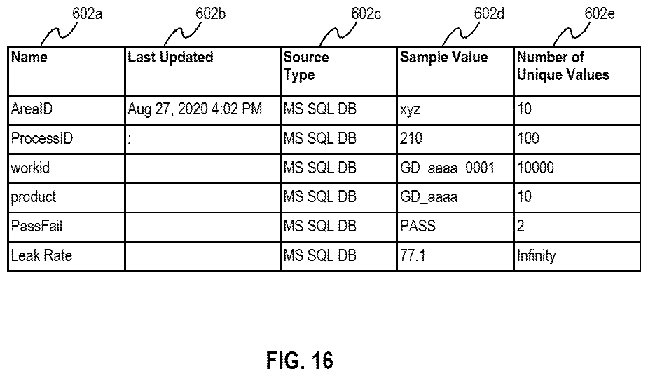

FIG. 15 illustrates an example of the IT data in the target company, in accordance with an example implementation. FIG. 16 illustrates an example of the data profile a in the target company, in accordance with an example implementation. As an example, the IT data profile 1021 for target may match closely with the Data Profile information in Template 102t. Consider the IT data in the target company as shown in FIG. 15 and the corresponding data profile in FIG. 16. This specific example is an anonymized version of data from an actual factory belonging to the same conglomerate as the reference factory considered earlier. The fields for the example of FIG. 15 can include, but are not limited to, the record ID 502a, the serial number 502b, the process ID 502c, the data type 502d, the data 502e, the pass/fail 502f, the area ID 502g, the date added 502h, and so on. Additional information can include the record ID 503a, the serial number 503b, the status 503c, the process ID 503d, the model ID 503e, the area ID 503f, and the date added 503g. The fields for the data profile in the target company can include, but are not limited to, the name 602a, the last updated date 602b, source type 602c, sample value 602d, and the number of unique values 602e.

As can be seen, the target data in FIG. 15 looks very different from the reference IT data in FIG. 9 even though in reality the two factories are producing the exact same product. The difference is largely in the storage mechanism (single XML file for reference vs 2 SQL table for Target). The data profiler can abstract some of the differences (see FIG. 10 versus FIG. 16) but differences still remain.

These differences can be learned in this current step by appropriate query. As an example, it can be learned that the quantity ‘Processcode’ for reference factory pertains to the same quantity as ‘ProcessID’ in target factory based on lexical similarity and also the similarity in number of unique values. In another example, it can be learned that in reference factory, ‘judge’ is the only Boolean and in target factory ‘PassFail’ is the only Boolean and so they must be related by the same business term.

At Step 2003-4, the flow checks if an appropriate template t was found based on the query performed in Step 2003-3. At Step 2003-5, if an appropriate template t was found in Step 20034, then the flow sets Automated Data Quality Checker 20033 output as ‘Good Quality’. This means the data profile is consistent with what had been observed earlier and hence is vouched for. However, if an appropriate template t was not found in Step 2003-4, then the flow sets Automated Data Quality Checker 20033 output as ‘Bad Quality’. This means that the data profile is inconsistent with what had been observed earlier and hence is an anomaly. Note that that all proper and non-anomalous data profiles are assumed to have already been observed during the reference factories during the business knowledge creation phase.

At Step 2003-6, if an appropriate template was found in Step 2003-4, then based on Knowledge Graph 2002 and derived template index t, the flow sets the Automated Business Logic Configurator 20031 as per the Business Terms Template 105t. For the above example, the flow sets the business terms of the target factory to be same as the that of the reference factory (which is also assumed as the business terms template) as shown in FIG. 11.

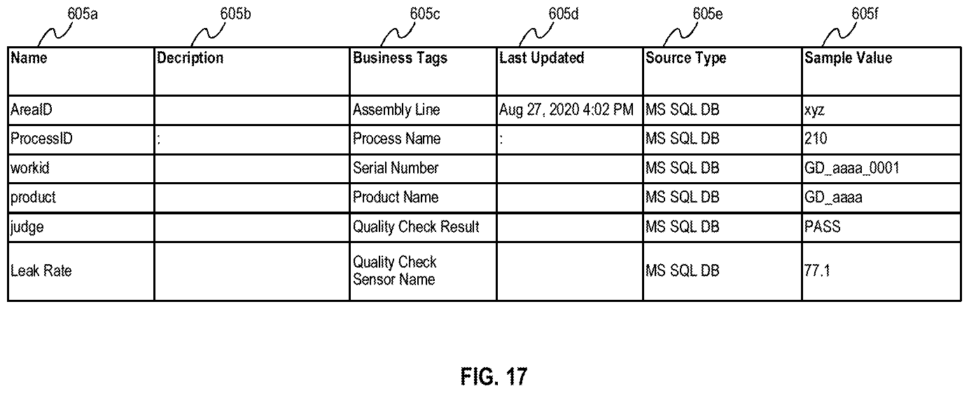

At Step 2003-7, if an appropriate template was found in Step 2003-4, then based on Knowledge Graph 2002 and derived template index t, the flow sets the Automated Business Data Configurator 20032 as per the Business Data Configurator Logic Template 106t. For the above example, this can lead to the business data in the target factory as shown in FIG. 17. Such business data in the data catalogue for the target factory can include, but is not limited to, the name 605a, the description 605b, the business tags 605c, last updated date 605d, source type 605e, and sample value 605f.

Through the example implementations described herein, it is possible to maintain a consistent data catalogue across various companies belonging to the same conglomerate. Further, the example implementations can be more efficient than the related art as it may be difficult to find appropriate data stewards in all companies, especially the ones that are being newly set up.

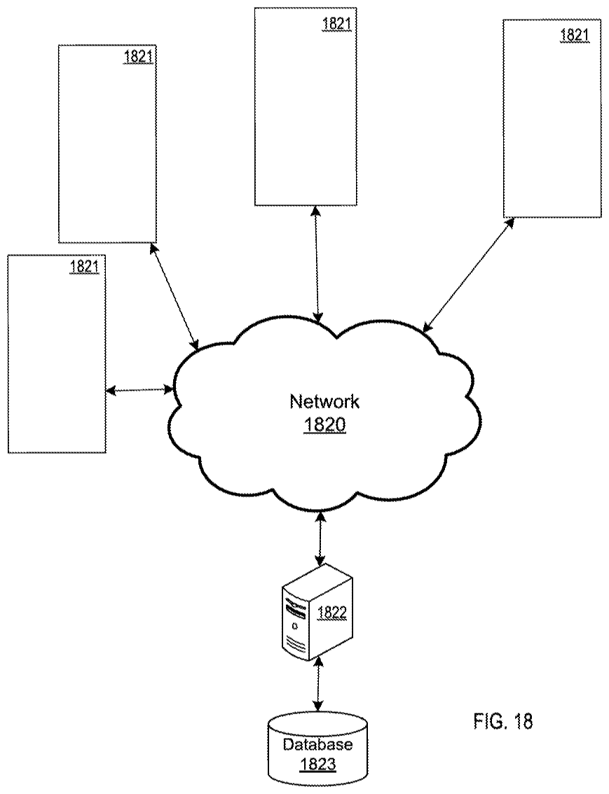

FIG. 18 illustrates a plurality of physical systems that are networked to a management apparatus, in accordance with an example implementation. One or more physical systems 1821 (e.g., factory with sensors, servers, enterprise resource planning platforms, databases, equipment, etc.) are communicatively coupled to a network 1820 (e.g., local area network (LAN), wide area network (WAN)) through the corresponding network interface of the sensor system installed in the physical systems 1821, which is connected to a management apparatus 1822. The management apparatus 1822 manages a database 1823, which contains historical data collected from each of the physical systems 1821. In alternate example implementations, the data of the physical systems 1821 can be stored in a central repository or central database such as proprietary databases that intake data from the physical systems 1821, or systems such as enterprise resource planning systems, and the management apparatus 1822 can access or retrieve the data from the central repository or central database. The data retrieved from the physical systems 1821 can involve any data as described in the present disclosure. As described in the present disclosure, the example of FIG. 18 can be a system for automating process setting to a target factory, which involves the factories under management (i.e. the one or more physical systems 1821), and a management apparatus 1822 configured to manage at least one reference factory and the target factory from the one or more physical systems 1821.

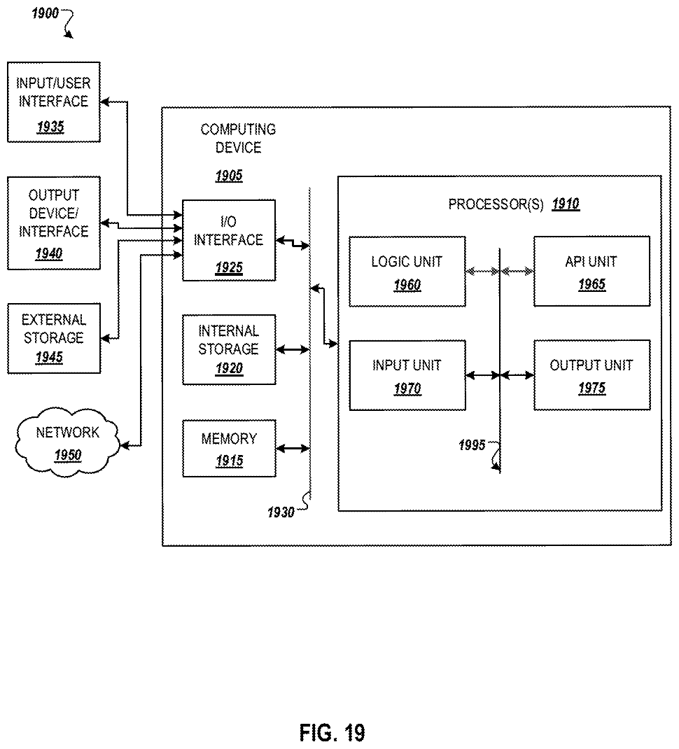

FIG. 19 illustrates an example computing environment with an example computer device suitable for use in some example implementations, such as a management apparatus 1822 as illustrated in FIG. 18. Computer device 1905 in computing environment 1900 can include one or more processing units, cores, or processors 1910, memory 1915 (e.g., RAM, ROM, and/or the like), internal storage 1920 (e.g., magnetic, optical, solid state storage, and/or organic), and/or I/O interface 1925, any of which can be coupled on a communication mechanism or bus 1930 for communicating information or embedded in the computer device 1905. I/O interface 1925 is also configured to receive images from cameras or provide images to projectors or displays, depending on the desired implementation.

Computer device 1905 can be communicatively coupled to input/user interface 1935 and output device/interface 1940. Either one or both input/user interface 1935 and output device/interface 1940 can be a wired or wireless interface and can be detachable. Input/user interface 1935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1940 may include a display, television, monitor, printer, speaker, braille, or the like. In some example implementations, input/user interface 1935 and output device/interface 1940 can be embedded with or physically coupled to the computer device 1905. In other example implementations, other computer devices may function as or provide the functions of input/user interface 1935 and output device/interface 1940 for a computer device 1905.

Examples of computer device 1905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1905 can be communicatively coupled (e.g., via I/O interface 1925) to external storage 1945 and network 1950 for communicating with any number of networked components, devices, and systems, including one or more computer devices of the same or different configurations. Computer device 1905 or any connected computer device can be functioning as, providing services of, or referred to as a server, client, thin server, general machine, special-purpose machine, or another label.

I/O interface 1925 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 1900. Network 1950 can be any network or combination of networks (e.g., the Internet, local area network, wide area network, a telephonic network, a cellular network, satellite network, and the like).

Computer device 1905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C. C++, C#, Java, Visual Basic, Python, Perl, JavaScript, and others).

Processor(s) 1910 can execute under any operating system (OS) (not shown), in a native or virtual environment. One or more applications can be deployed that include logic unit 1960, application programming interface (API) unit 1965, input unit 1970, output unit 1975, and inter-unit communication mechanism 1995 for the different units to communicate with each other, with the OS, and with other applications (not shown). The described units and elements can be varied in design, function, configuration, or implementation and are not limited to the descriptions provided. Processor(s) 1910 can be in the form of hardware processors such as central processing units (CPUs) or in a combination of hardware and software units.

In some example implementations, when information or an execution instruction is received by API unit 1965, it may be communicated to one or more other units (e.g., logic unit 1960, input unit 1970, output unit 1975). In some instances, logic unit 1960 may be configured to control the information flow among the units and direct the services provided by API unit 1965, input unit 1970, output unit 1975, in some example implementations described above. For example, the flow of one or more processes or implementations may be controlled by logic unit 1960 alone or in conjunction with API unit 1965. The input unit 1970 may be configured to obtain input for the calculations described in the example implementations, and the output unit 1975 may be configured to provide output based on the calculations described in the example implementations.

Processor(s) 1910 can be configured to execute a method or instructions, which can involve create templatized business terms, templatized business data configurator logics, and a templatized data profile by machine learning from training data from the at least one reference factory as illustrated in FIGS. 6 to 8 and FIGS. 12 to 14; store the templatized business terms, the templatized business data configurator logics, and the templatized data profile into a knowledge graph as illustrated in FIG. 13 and as executed by the business knowledge creation module 2001 as illustrated in FIGS. 5 and 6; query the knowledge graph with a data profile of the target factory to obtain corresponding templated business terms and corresponding templated business data configurator logics as described in FIGS. 5, 11, and 15 via automated business logic configurator 20031 and automated business data configurator 20032; and apply the corresponding templated business terms and the corresponding templated business data configurator logics to a data catalogue of the target factory as illustrated in FIG. 17.

Depending on the desired implementation the training data can involve business terms, business data configurator logics, and a data profile of the at least one reference factory. Such training data can be obtained from the one or more factories under management over the system as illustrated in FIG. 18 using the data profiler and data crawler to intake into multi entity knowledge module as illustrated in FIGS. 1 to 5.

In the example of FIG. 18, a new reference factory and/or a new target factory can be flexibly incorporated into the system over a network and placed under management by the management apparatus. In such a situation, processor(s) 1910 can be configured to update the templatized business terms, the templatized business data configurator logics, and the templatized data profile in the knowledge graph by the machine learning from the training data of at least one new reference factory, query the knowledge graph with the data profile of a new target factory to obtain new corresponding templated business terms and new corresponding templated business data configurator logics via a new automated business logic configurator 20031 and new automated business data configurator 20032; and apply the new corresponding templated business terms and the new corresponding templated business data configurator logics to a data catalogue of the new target factory in a similar manner as illustrated in FIG. 17.

Processor(s) 1910 can be configured to execute the method or instructions above, and be further configured to provide feedback on data quality and anomalies of the target factory by comparing the data profile of the target factory with the templatized business terms, the templatized business data configurator logics, and the templatized data profile in the knowledge graph as illustrated in the flow of FIG. 14.

Processor(s) 1910 can be configured to execute the method or instructions above, wherein the creating the templatized business terms, the templatized business data configurator logics, and the templatized data profile by machine learning from training data from at least one reference factory can involve establishing correlations between business terms, business data configurator logics, and a data profile of the at least one reference factory using neural linguistic programming (NLP); clustering the business terms, the business data configurator logics, and the data profile of the at least one reference factory into clusters; and determining the templatized business terms, the templatized business data configurator logics, and the templatized data profile from the clusters as illustrated in FIG. 6.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for automating process setting to a target factory, comprising:
creating templatized business terms, templatized business data configurator logics, and a templatized data profile by machine learning from training data from at least one reference factory;
storing the templatized business terms, the templatized business data configurator logics, and the templatized data profile into a knowledge graph;
querying the knowledge graph with a data profile of the target factory to obtain corresponding templated business terms and corresponding templated business data configurator logics; and
applying the corresponding templated business terms and the corresponding templated business data configurator logics to a data catalogue of the target factory.

2. The method of claim 1, wherein the training data comprises business terms, business data configurator logics, and the data profile of the at least one reference factory.

3. The method of claim 1, further comprising:
updating the templatized business terms, the templatized business data configurator logics, and the templatized data profile in the knowledge graph by the machine learning from the training data of at least one new reference factory,
querying the knowledge graph with the data profile of a new target factory to obtain new corresponding templated business terms and new corresponding templated business data configurator logics; and
applying the new corresponding templated business terms and the new corresponding templated business data configurator logics to the data catalogue of the new target factory.

4. The method of claim 1, further comprising providing feedback on data quality and anomalies of the target factory by comparing the data profile of the target factory with the templatized business terms, the templatized business data configurator logics, and the templatized data profile in the knowledge graph.

5. The method of claim 1, wherein the creating the templatized business terms, the templatized business data configurator logics, and the templatized data profile by the machine learning from the training data from the at least one reference factory comprises:
establishing correlations between business terms, business data configurator logics, and a data profile of the at least one reference factory using neural linguistic programming (NLP);
clustering the business terms, the business data configurator logics, and the data profile of the at least one reference factory into clusters; and
determining the templatized business terms, the templatized business data configurator logics, and the templatized data profile from the clusters.

6. A non-transitory computer readable medium, storing instructions for automating process setting to a target factory, the instructions comprising:
creating templatized business terms, templatized business data configurator logics, and a templatized data profile by machine learning from training data from at least one reference factory;
storing the templatized business terms, the templatized business data configurator logics, and the templatized data profile into a knowledge graph;
querying the knowledge graph with a data profile of the target factory to obtain corresponding templated business terms and corresponding templated business data configurator logics; and
applying the corresponding templated business terms and the corresponding templated business data configurator logics to a data catalogue of the target factory.

7. The non-transitory computer readable medium of claim 6, wherein the training data comprises business terms, business data configurator logics, and the data profile of the at least one reference factory.

8. The non-transitory computer readable medium of claim 6, the instructions further comprising:
updating the templatized business terms, the templatized business data configurator logics, and the templatized data profile in the knowledge graph by the machine learning from the training data of at least one new reference factory,
querying the knowledge graph with the data profile of a new target factory to obtain new corresponding templated business terms and new corresponding templated business data configurator logics; and
applying the new corresponding templated business terms and the new corresponding templated business data configurator logics to a data catalogue of the new target factory.

9. The non-transitory computer readable medium of claim 6, further comprising providing feedback on data quality and anomalies of the target factory by comparing the data profile of the target factory with the templatized business terms, the templatized business data configurator logics, and the templatized data profile in the knowledge graph.

10. The non-transitory computer readable medium of claim 6, wherein the creating the templatized business terms, the templatized business data configurator logics, and the templatized data profile by machine learning from training data from at least one reference factory comprises:
establishing con-elations between business terms, business data configurator logics, and a data profile of the at least one reference factory using neural linguistic programming (NLP);
clustering the business terms, the business data configurator logics, and the data profile of the at least one reference factory into clusters; and
determining the templatized business terms, the templatized business data configurator logics, and the templatized data profile from the clusters.

11. A system for automating process setting to a target factory, comprising:
a management apparatus configured to manage at least one reference factory and the target factory, the management apparatus comprising:
a processor, configured to:
create templatized business terms, templatized business data configurator logics, and a templatized data profile by machine learning from training data from the at least one reference factory;
store the templatized business terms, the templatized business data configurator logics, and the templatized data profile into a knowledge graph:
query the knowledge graph with a data profile of the target factory to obtain corresponding templated business terms and corresponding templated business data configurator logics; and
apply the corresponding templated business terms and the corresponding templated business data configurator logics to a data catalogue of the target factory.

12. The system of claim 11, wherein the training data comprises business terms, business data configurator logics, and a data profile of the at least one reference factory.

13. The system of claim 11, wherein the processor is configured to:
update the templatized business terms, the templatized business data configurator logics, and the templatized data profile in the knowledge graph by the machine learning from the training data of at least one new reference factory,
query the knowledge graph with the data profile of a new target factory to obtain new corresponding templated business terms and new corresponding templated business data configurator logics; and
apply the new corresponding templated business terms and the new corresponding templated business data configurator logics to the data catalogue of the new target factory.

14. The system of claim 11, wherein the processor is configured to provide feedback on data quality and anomalies of the target factory by comparing the data profile of the target factory with the templatized business terms, the templatized business data configurator logics, and the templatized data profile in the knowledge graph.

15. The system of claim 11, wherein the processor is configured to create the templatized business terms, the templatized business data configurator logics, and the templatized data profile by the machine learning from the training data from the at least one reference factory by:
establishing correlations between business terms, business data configurator logics, and a data profile of the at least one reference factory using neural linguistic programming (NLP);
clustering the business terms, the business data configurator logics, and the data profile of the at least one reference factory into clusters; and
determining the templatized business terms, the templatized business data configurator logics, and the templatized data profile from the clusters.
